(19) United States
(12) Patent Application Publication
(10) Pub. No.: US 2025/0011254 A1
(43) Pub. Date: Jan. 9, 2025

(54) Method And Apparatus For Treatment of Organic Waste

(71) Applicant: Bio N IP Pty Ltd, Hornsby NSW (AU)

(72) Inventor: Peter Fusarelli, Hornsby (AU)

(21) Appl. No.: 18/027,582

(22) PCT Filed: Sep. 21, 2021
(86) PCT No.: PCT/IB2021/058618

§ 371 Date: Mar. 21, 2023

(30) Foreign Application Priority Data
Sep. 21, 2020 (AU) 2020903386

(51) Int. Cl. C05F 17/50; C05F 17/05; C05F 17/40; C05F 17/60

(52) U.S. Cl. CPC C05F 17/50; C05F 17/05; C05F 17/40; C05F 17/60

(57) ABSTRACT

A method for treating organic waste material, the method comprising the steps of: —treating a quantity of organic waste using an anerobic digestion process; and then —treating at least some of the product from the anaerobic digestion process using a vermiculture process, resulting in the output of solid and liquid fertilizer products.

### TECHNICAL FIELD

This disclosure relates to an apparatus for treatment of organic waste and to a method for use of the treatment apparatus.

Aspects, features, and advantages will become further apparent from the following detailed description when read in conjunction with the accompanying drawings which form a part of this disclosure and which illustrate, by way of example, principles of the inventions disclosed.

### BACKGROUND

From a worldwide perspective, anaerobic digestion of sewage sludge is the most widespread use of anaerobic digestion, and the volume of digesters found at some of the large wastewater treatment facilities in USA is far greater than all the combined thermophilic digester volume in the world. The US EPA has further launched the need for special disinfection of biosolids such as digested sewage sludge before it can be deposited on agricultural land. Mesophilic digested biosolid will therefore have more restricted use and digestion at thermophilic temperatures or other sanitising treatments may be necessary to meet such EPA standards.

Thermophilic temperatures kill most pathogenic bacteria and most viruses. The effect on the pathogens is known to be a combined effect of temperature and the anaerobic environment. However, some viruses will not be killed at a digestion temperature of 55° C. and the demand for thermophilic disinfection of biosolids can be expected to increase in the future. However, thermophilic digestion at extreme temperatures of 65° C. or more can destroy many other valuable microorganisms which could otherwise be necessary or useful microbes for downstream biological uses of the treated waste.

### DESCRIPTION OF THE FIGURES

The accompanying drawings facilitate an understanding of embodiments of the apparatus, system and method of the disclosure.

FIG. 1 shows a schematic flow diagram view of a process for treating organic waste which, in accordance with one embodiment of the present disclosure, involves passing it through various stages of decontamination, anaerobic digestion, and vermiculture processing, to produce offgases for re-use and energy generation, and an organic humus fertiliser for use in the regeneration of nutrient-depleted soil;

FIG. 2 shows a schematic view of various apparatus used in the Step 1 feed intake and decontamination portion of the process for treatment of organic waste, in accordance with the embodiment of FIG. 1;

FIG. 3 shows a schematic view of various apparatus used in the Step 2 anaerobic digestion portion of the process for treatment of organic waste, in accordance with the embodiment of FIG. 1;

FIG. 4 shows a schematic view of various apparatus used in the Step 6 fertiliser product packaging portion of the process for treatment of organic waste, in accordance with the embodiment of FIG. 1;

FIG. 5 shows a schematic view of various apparatus used in the Step 3 offgas extraction, processing and re-use portion of the process for treatment of organic waste, in accordance with the embodiment of FIG. 1;

FIGS. 6 to 19 show various views of apparatus used in the Step 2 anaerobic digestion portion of the process for treatment of organic waste, in accordance with the embodiment of FIG. 1;

FIGS. 20 to 34 show various views of apparatus used in the Step 5 vermiculture portion of the process for treatment of organic waste, in accordance with the embodiment of FIG. 1.

### DETAILED DESCRIPTION

The inventors have developed a processing system, methodology and apparatus for treatment of any type of organic waste material, which involving passing it through various stages of decontamination, anaerobic digestion, and vermiculture processing.

The main output from the system is a high-quality organic humus fertiliser for use in the regeneration of nutrient-depleted soils, to support food production.

In operation, the process is continuous and can be automated. It is also designed to be scalable, which allows capacity to be met without comprising efficiency or creating huge capital expenses.

There are no greenhouse gas emissions, since CO₂, ammonia and carbon are captured.

The inventors have designed this new multi-stage process to convert organic waste to useful products which can be re-used on site, or sold for profit. Apart from the humus fertiliser to support food production, such products may include carbon sources suitable for electric power generation, as well as steps which capture heat energy and greenhouse gases from being emitted.

The re-use of the process off-gases can include combustion for power generation to give some energy self-sufficiency to the unit operations on site.

The system consists of the steps of sorting and doing some preliminary physical preparation of a feed material, followed by anaerobic digestion along with gas production, gas recovery, and heat and electricity generation, followed then by an automated vermiculture operation, resulting in the production of carbon-rich humus fertiliser.

This system can assist different industries such as agricultural farms, sewage plants, olive groves and meat processing plants to reimagine a more sustainable process because of the integration of process operations for waste treatment and fertiliser generation.

The system uses anaerobic processes including a unique anaerobic digester tank and frame to accomplish the waste digestion and associated gas capture. The fertilizer production is accomplished, in part, by use of a non-motorised, “friction-drive” conveyor module which is part of an automated vermiculture treatment system.

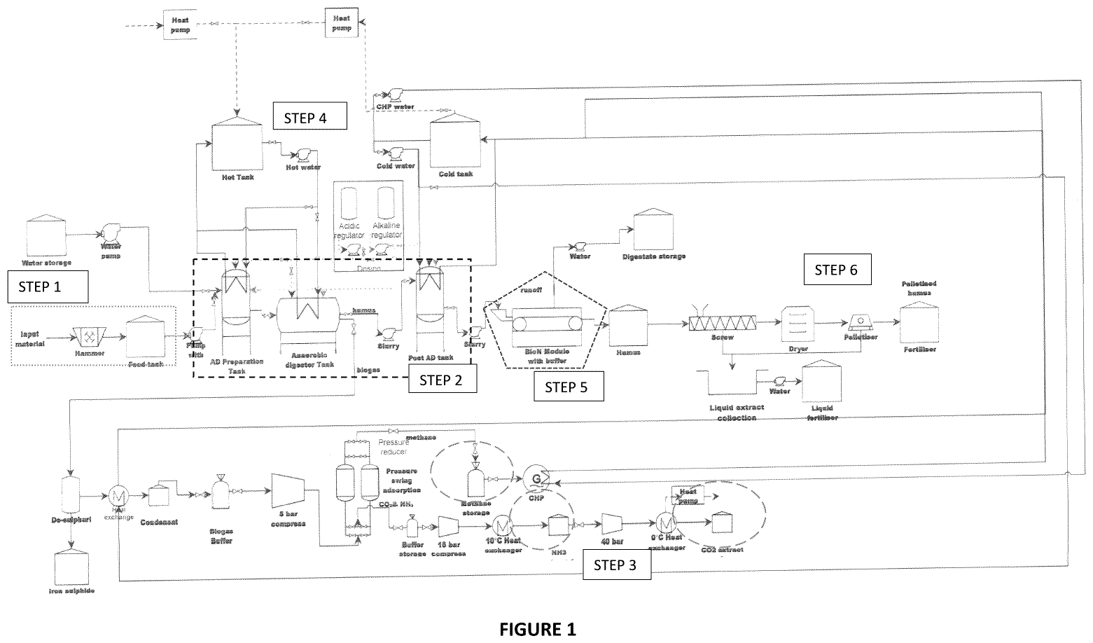

The organic waste treatment system comprises four (4) principal stages some of which operate in a continuous or batch-wise manner, but all automated. These parts of the process are generally shown in FIG. 1 by a STEP # label, indicating their position in the process flowchart:
1. Preparation and decontamination of intake feed materials—ensuring that the feed comprises organic materials, which may even need to be quite specific in composition (STEP 1);
2. Anaerobic digestion process—for the initial decomposition/breakdown of the organic waste, and release of off-gases and production of energy (STEP 2);
3. Vermiculture process—using worm farming to digest and convert the organic materials to yield the humic fertiliser product (STEP 5);
4. Fertiliser product preparation—to produce solid and liquid fertiliser materials, which may also be compounded or enhanced with other fertilisers (STEP 6).

There are also two ancillary stages operating as a part of the system, for:
product gas extraction and processing (STEP 3), and for
energy production and recapture processes (STEP 4).

### Step 1—Preparation and Decontamination of Intake Feed Materials

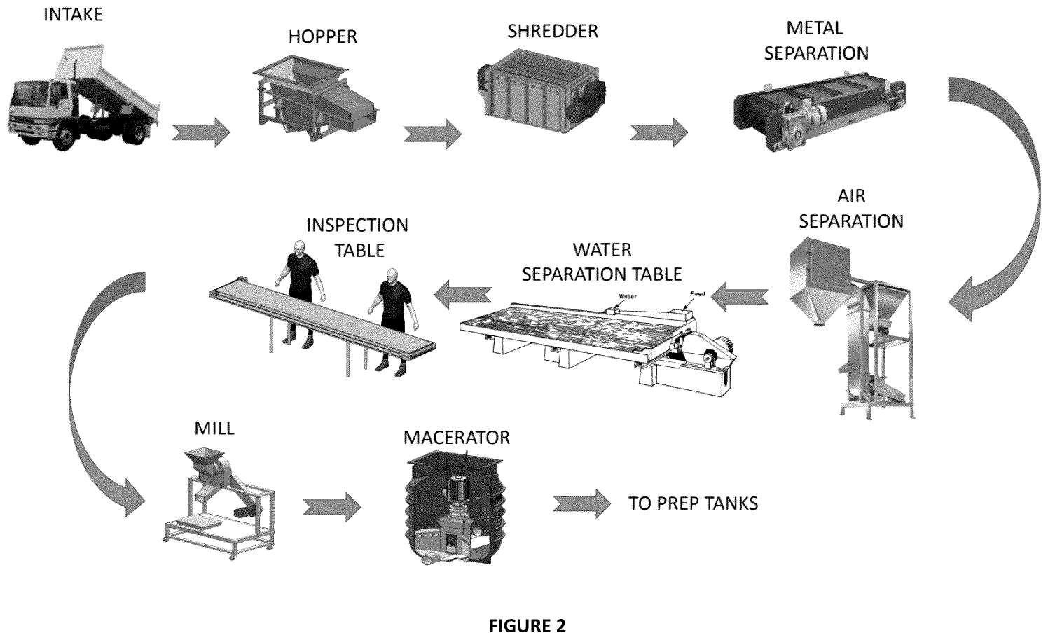

The preparation stage includes the reduction in particle size of oversize particles and the removal of any unwanted contaminants. Most of the equipment being used comprises readily sourced materials sorting and handling machinery, which is able to be locally and internationally sourced. The selected separation techniques vary depending on the nature and source of materials, but some examples are illustrated in FIG. 2 and include specific gravity separators (water, air), screens, shredders, mills, macerators, and so on. Hand sorting to remove specific objects visually may also be required.

### Step 2—Anaerobic Digestion Process

An anaerobic digestion (AD) process allows for the development of microbiological cultures to stabilise the decomposition process and to optimise fertiliser content.

The end-use agricultural purpose, or soil enhancement needed, for example cultivating a particular crop, can be predetermined depending on the chosen organic feed materials input. Over time, users can develop a feed materials database for the anerobic digestors as a part of the design criteria for a commercial facility. Such a database may use the knowledge of local organic feed materials to optimise the digestion processes, and improve the digestion efficiency.

Anaerobic digestion can be carried out at ambient temperature. Heat pumps are used to conduct digestion when using mesophilic or thermophilic microorganisms. Mesophilic bacteria grow and thrive in a moderate temperature range between, and the optimum temperature range for these bacteria in anaerobic digestion is 30° C. to 38° C. Thermophilic temperatures of 50 to 55° C. have been used for treatment of animal waste from farms in biogas plants or for treatment of the organic fraction of municipal solid waste, with the main reason for applying thermophilic temperatures being a better sanitising effect at the higher process temperature compared to mesophilic temperatures, and the need for a lower retention time.

AD of sewage sludge produces biogas that can be captured to offset wastewater treatment cost and reduces the amount of sludge. One of the most important operational parameters influencing the AD processing rate is temperature. Consequently, the use of thermophilic and the mesophilic modes of waste treatment AD affect biogas yield, process speed and stability, with thermophilic sludge AD having the faster biochemical reaction rate. Equally important but not studied sufficiently until now was the influence of temperature on the digestate quality, which is expressed mainly by the sludge dewatering ability, and the reject water quality (chemical oxygen demand, ammonia nitrogen, and pH). In the field, the comparison of thermophilic and mesophilic digestion processes has often been inconclusive. Hence, recommendations for optimised technologies have not yet been done.

### Anaerobic Digestion Equipment

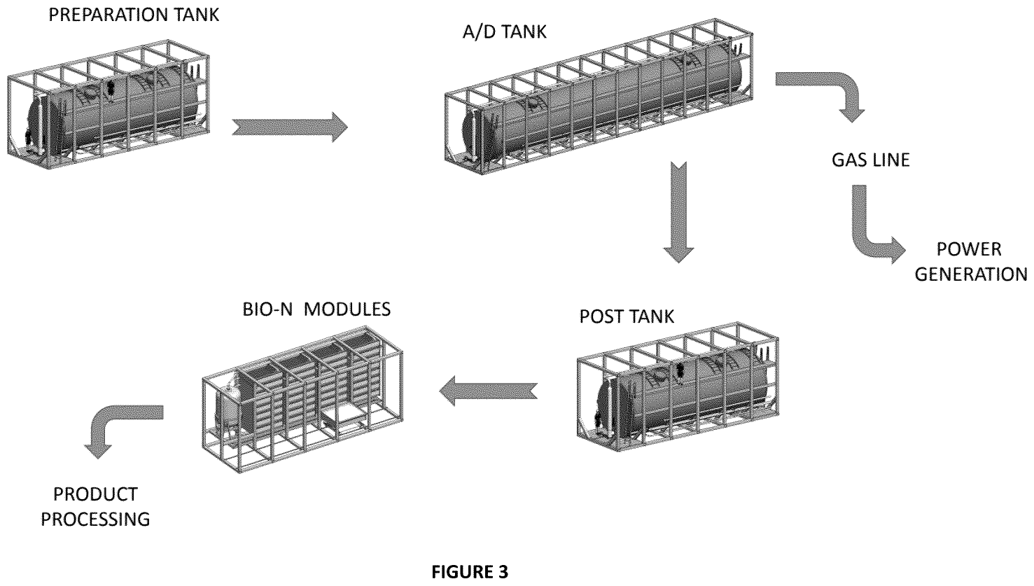

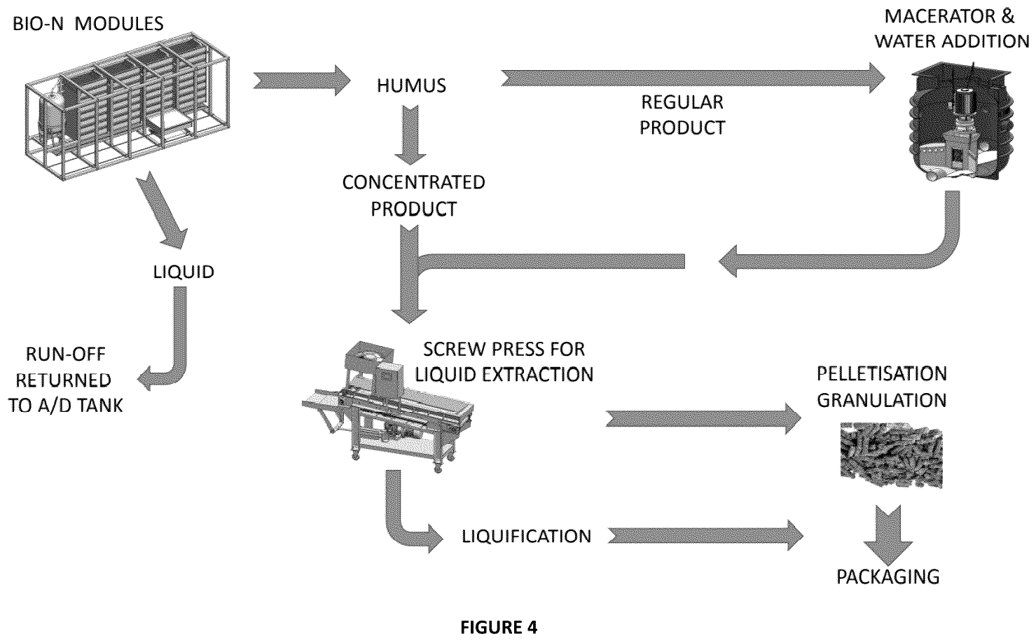

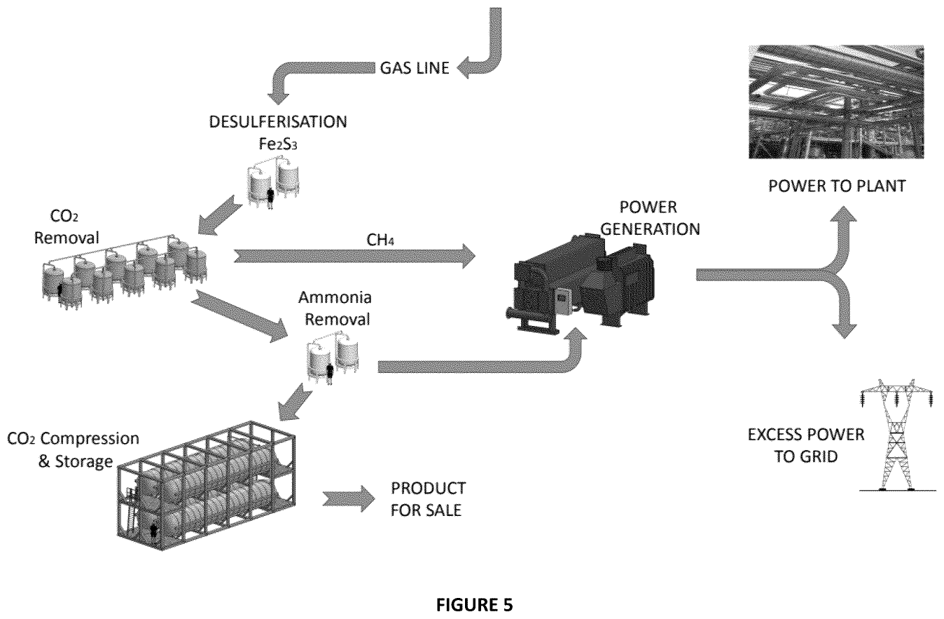

The anaerobic digestion (AD) process is configured with 3 different types of tanks used for each of the distinct stages of the process, as shown schematically in FIG. 1, at STEP 2, and also in FIG. 3. Those tank stages are, namely:
organic feed preparation in the Preparation Tank (30),
digestion in the AD Tank(s) (40), and
post-digestion in the Post-AD Tank (50).

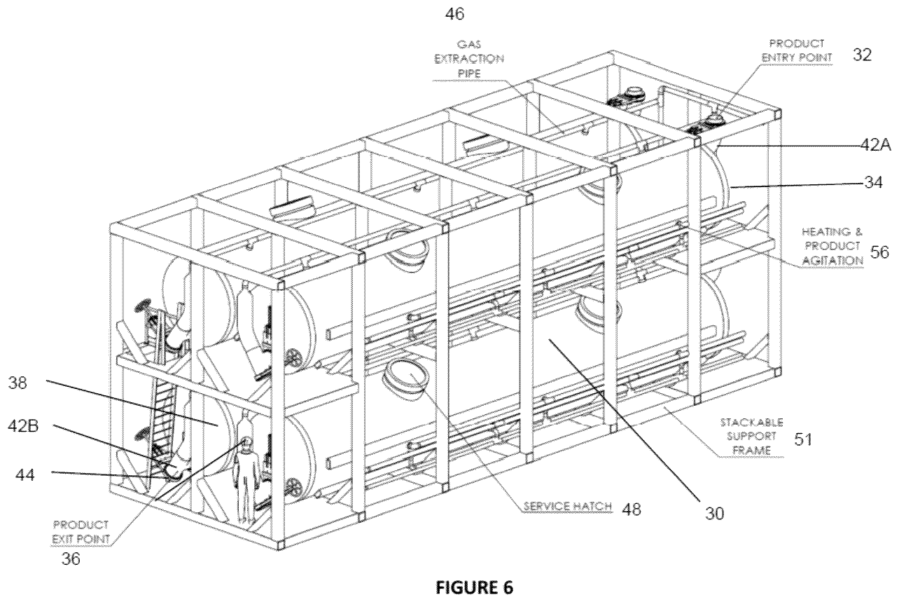

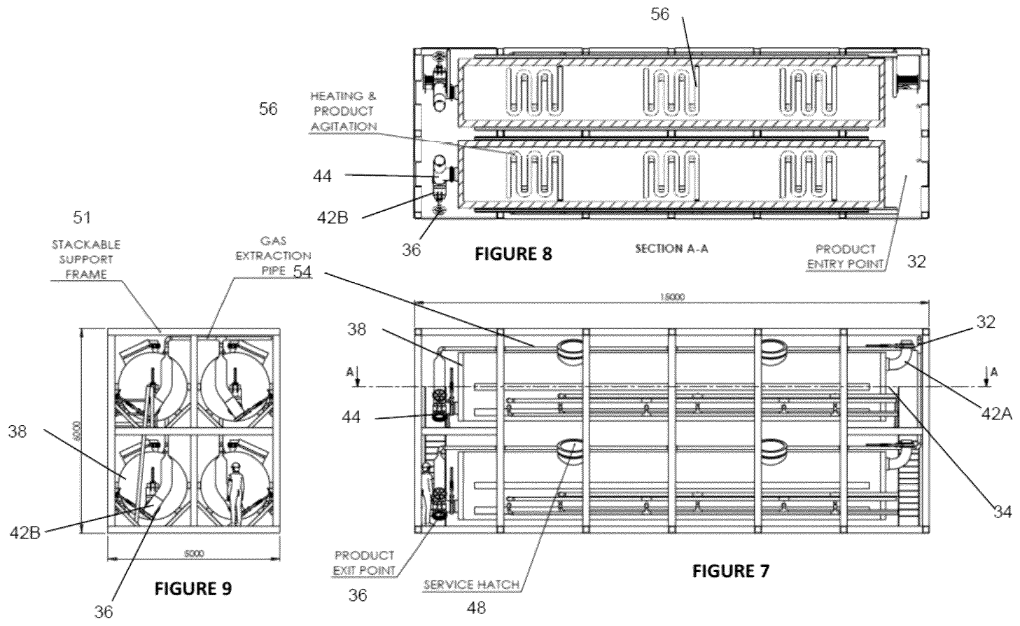

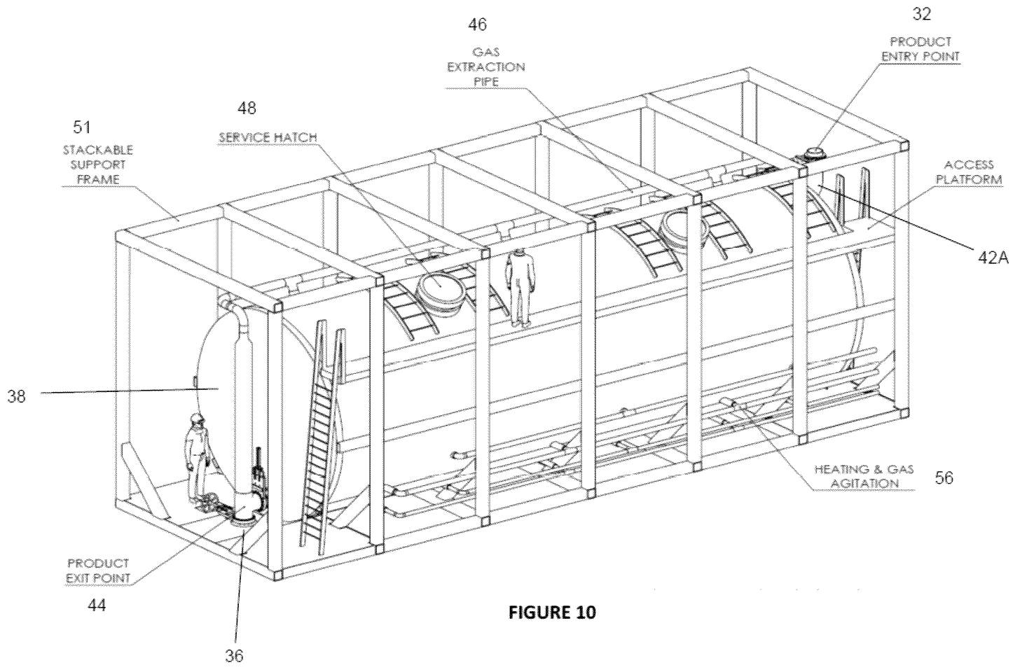

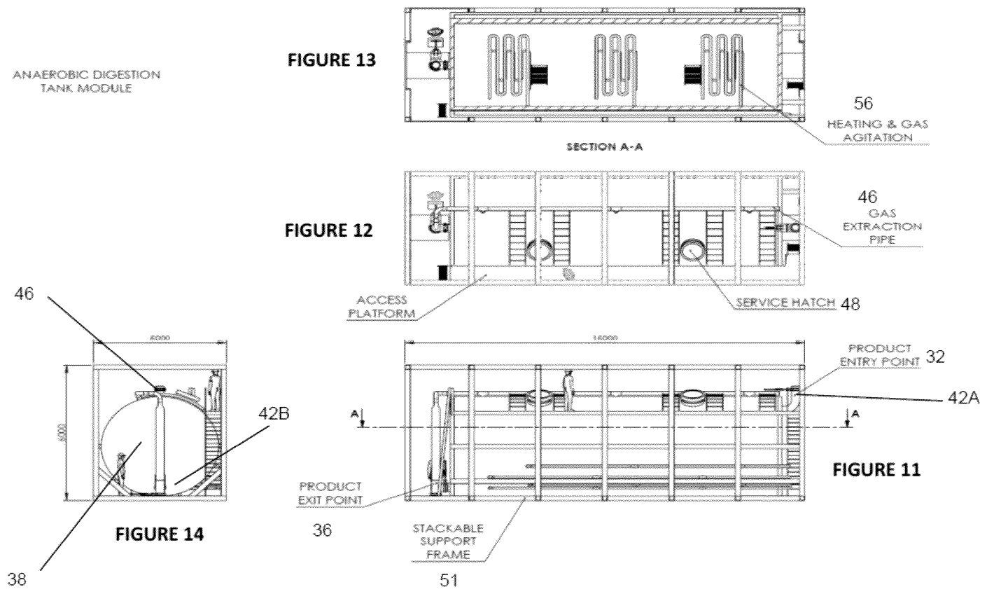

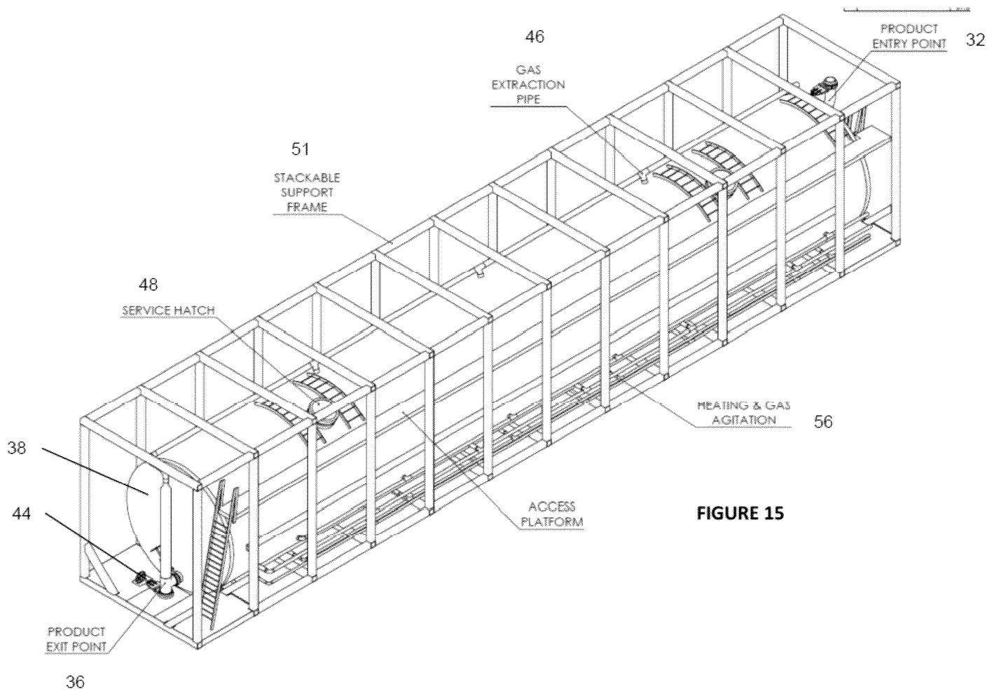

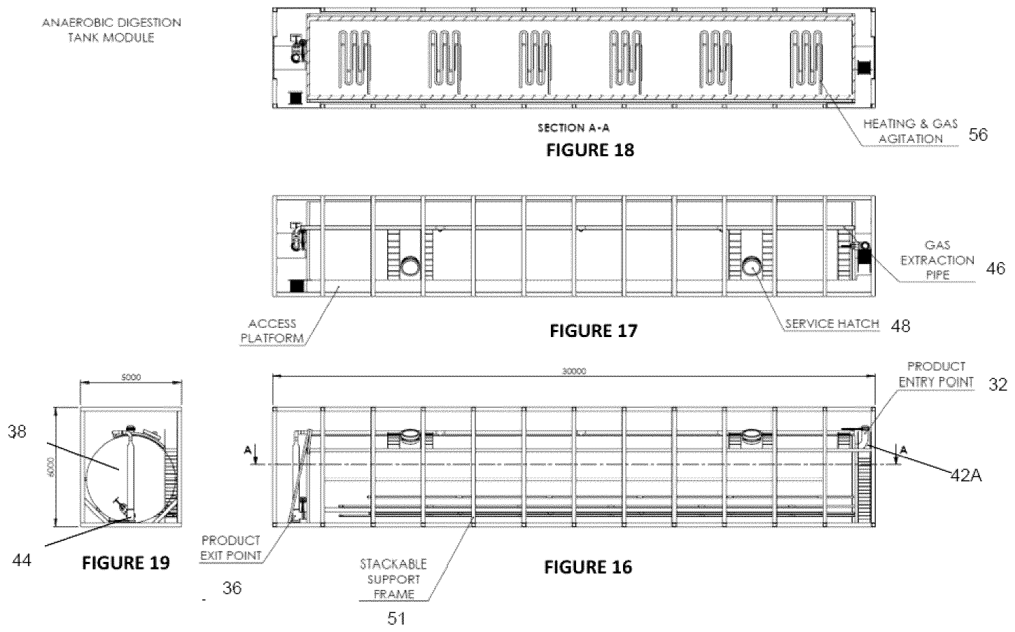

FIGS. 6 to 25 show various views of certain embodiments of these PT, AD and post-AD tanks for the anaerobic digestion process, each set within a stackable support frame 51. Like features in each embodiment will be given like numerals, for convenience of reference.

### Preparation Tank(s) (PT)

Each Preparation Tank (30) receives the slurry of finely milled (<=5 mm particle size) intake material. Key functions conducted within a PT are:
Mixing the macerated material with water to create uniformly mixed slurry;
Correcting the slurry to the required solid-liquid ratio;
Facilitating the primary steps of anaerobic digestion—hydrolysis and acidogenesis;
Correcting the slurry to the required process temperature;
Correcting pH before the AD process;
Providing any inoculant top-up, if required; and
Decontamination of the intake material, if required.

Horizontal HDPE pipe spiral-wound cylindrical tanks (30) of selected sizes are used as preparation tanks. Size selection is usually done as part of the plant design process and is linked to the amount of intake, required redundancy, and layout of the cells. A typical 4 m internal diameter, 30 m long tank has a total tank capacity of 377 cubic metres.

Regardless of the total available volume, the operational capacity of a tank is limited to a designed operation capacity: 80% of the total volume, and a maximum operation capacity: 90% of the total volume. A tank should not be operated above the specified maximum operating capacity limit. These volume clearances are provided to:
Ensure enough gas space is available above the liquid level;
Avoid liquid or solid material entering the gas pipeline;
Avoid foam entering the gas pipeline.

### General Layout of a Preparation Tank (PT)

A PT has:
Inlet region—located at one end 34 of the tank 30;
Outlet region—located at an opposite end 38 of the tank 30;
Gas take-off region—located on top, closer to outlet end 38; and
Heating & agitation region—located to one side of the tank

### Surry Inlet & Outlet

The inlet 32 to the tank 30 is located at one of the tank ends 34 and the outlet 36 is in the opposite end 38. The inlet 32 is located at the maximum height, near to top which will avoid backflow of material and in contrast, the outlet 36 will be at a minimum height, near to bottom side to allow drainage from the tank 30.

Slurry inlet and outlet pipes 42A, 42B are:
200 mm internal diameter pipes;
Fitted with knife valves;
   Inlet valve—automated;
   Drain valve—manual with a normally closed position;
   Outlet pump isolation valve—Manual with a normally open position;
   Outlet—Discharge valve—automated.

A discharge pump 44 is fitted at the outlet end 38 to move the material from the preparation tank to AD. Outlet pump isolation valve can be manually turned to a closed position only in an event of isolating the tank 30.

### Gas Outlet

A gas outlet pipe 46 of 100 mm internal diameter is located on the top side of the tank, closer to the slurry outlet end of the tank. Automated gate valves are provided on this gas line to isolate the tank from the arterial gas pipeline based on the operating condition:
Gas outlet isolation valve—automated;
Purging valve—automated.

Even though automated, it is recommended to verify valve status when the operating condition of a tank is changed.

### Manholes

Manholes 48 can be also found on the top for access into the tanks in the rare event of tank washout/internal repair. These are 800 mm wide. Manhole access is restricted to trained service personnel using biometric entry to the tank cells.

### Heating and Agitation Systems

The heating of the slurry is done externally using a unique heat exchanging mechanism located on one side of the tank. Key properties of heating & agitation system are:
Slurry from the preparation tank 30 will be pumped through a pipe 54 which acts as a shell in a shell & tube heat exchanger 56 and is looped back into the tank 30.
The tubes in the heat exchanger 56 will receive hot fluid from the hot tank system and this heat will be transferred to the slurry until the whole tank fluid reaches the required temperature. Multiples of such heat exchangers 56 are provided on the side of a preparation tank 30, typically 7 sets in a 4 m diameter×30 m long tank 30.
The slurry is sucked by the action of the discharge pump 44 from the bottom side end of the pipe 54 and is discharged back into the tank 30 at the top side end of the pipe 54 to facilitate tank 30 operation at any slurry fill level. This slurry movement at multiple locations also creates agitation inside the tank which will prevent excessive sedimentation.
This heat exchanger 56 mechanism is also connected with a pH correction system, which is accomplished using a pH meter and a dosing pump connected to a pH correction port. If any pH adjustment is required for the slurry at any location in the tank, an adjusting solution will be pumped to the nearest heat exchanging mechanism via the sampling/rnoculation port and thereby addresses any such variation inside the tank 30.

Any number of separate line connectors for introducing acidic and alkaline solutions, or other reagents can be connected herein. Similarly, the port 64 is available for the injection of inoculants or other additives if required in the process.

Multiple numbers of such heat exchange and pH correction systems are used over the length of the tank 30 to allow separate monitoring and correction of the slurry properties such as temperature and pH at each tank region, as well as for providing redundancy to the heating and agitation system—a failure of any one such system will not affect the operation of tank 30, as a whole. This also simplifies and speeds up in-situ maintenance tasks.

### PT Tank Operation

Preparation tanks execute a batch process, in which the tank will be filled to a required level, then closed off, and will not accept any further material until it is completely discharged. A minimum of three preparation tanks are required for the proper management of intake material. These tanks can operate in a sequence; filling, preparation and discharge.

### Filling

1 All valves except the slurry inlet valve are in the closed position.
2 Open the purge gas inlet and outlet valves as the filling starts.
3 Gas will be purged through an activated carbon filter at the exhaust before being released into the atmosphere.
4 Fill the empty preparation tank with finely milled intake material using the slurry pump.
5 Add water until the required dry solids ratio is obtained.
6 Make sure that the tank is filled up to the required level and does not exceed the maximum operating capacity limits.
7 Turn off the slurry pump and close the inlet slurry valve.
8 After pushing a set volume of carbon dioxide into the tank to ensure all of the air is removed, both inlet and outlet purging valves are closed.
9 The system is then sealed and is in an anaerobic state (absence of oxygen).

### Preparation of Required Process Conditions

1 Open the main biogas outlet valve.
2 Open the heating/agitation valves.
3 Start the heat exchanging/agitation pumps.
4 Add inoculants or pH correction fluids, if necessary, by opening the corresponding valves on the heat exchanger 56 pipes.
5 Continue the process until the required process conditions are achieved and maintained.
6 The hydrolysis and acidogenesis process will be completed in an anaerobic state during the set preparation cycle time.

### Slurry Transfer to AD Tanks

1 After completing the preparation cycle time, identify the destination AD tank(s) to which the prepared material is to be transferred.
2 Open the valve on the slurry outlet pipe 42B and the valves on the destination path.
3 Move the slurry to the anaerobic digestion (AD) tanks 40 using the slurry discharge pump 44.
4 Close the slurry outlet valve and heating & agitation valves once the tank is emptied.

### Biogas Purging

1 The tank will be full of biogas at this point due to the suction action during the discharge. Open the purge gas inlet.
2 Purging gas (CO₂) will push the biogas through the main biogas outlet since the purging gas outlet is closed.
3 After pushing a set volume of carbon dioxide to ensure all the biogas is removed, both purging inlet valve and main gas outlet valves are closed.
4 Tank is now ready for the next fill cycle.

### Environmental Control

Each preparation tank is housed in a structural cell and will have the environment around it automatically regulated to minimise the heat loss from the tank.
The tank environmental temperatures should not be lower than 20° C. from the tank internal temperature/process temperature, for example if a process is thermophilic (55° C.), then the tank cell temperature should not fall below 35° C.

Deviations in the temperature from the set limits will be alarmed and necessary actions for rectification should be followed. Temperature control being automated, the reason for failures include:
Leakage of air to/from the cell
Poor insulation
Sudden drastic changes in ambient temperatures

### Ventilation:

Forced air ventilation using a fan is present in each cell. Clean air from the atmosphere will be taken in and stale air inside the cell will be pushed out during an air exchange ventilation process.
A minimum of 1 complete air exchange will be done every hour.
In the event of gas leakage or before human access inside a cell, the ventilation system forces a separate air exchange

### 4. Cleaning & Maintenance

To remove sedimentation and scales from the walls of a tank, a planned cleaning cycle can be executed. This requires the tank to be isolated from the whole plant and the slurry outlet is directed towards the drainage.

Since there is no internal heating or agitation devices, most of the maintenance activities can be done using isolating valves at the heat exchanging systems externally. Sensors should be checked and cleaned at least once in 6 months.

### 5. Control System

Preparation tanks can be controlled using the master control system via the cell controller.
The whole preparation process, except the filling command, is automated.
On activating the fill operation, the system identifies the prep tank to be filled and completes the operation automatically.

Using the various sensor measurements, the conditions inside all the preparation tanks can be monitored in real-time and this system will prompt for any detection of faults, errors, or malfunction immediately.

### Anaerobic Digester (AD) and Frame

The AD tanks were selected for manufacture from High-Density Polyethylene (HDPE) because the end use requirement was for an item that is chemically inert for biogas production capable of storing around 350,000 kg of liquid at a temperature of 55° C. at 90% full capacity. The AR tank can also be configured to have the following characteristics:
30 m in length and 4 m in diameter;
internal baffles;
external steel support frames;
access ports to the upper section of the tank; and
heating and gas agitation.
fully sealed;
developed using inert materials with a high level of corrosion resistance to acidic gases and liquids;
capable of generating a plug flow system for storing materials which enter from one end and gradually are transferred to the other end;
permits scaling in a multi-stage process; and is
capable of operating at temperatures in the thermophilic range (45-60° C.);

An exemplary anaerobic digester tank frame comprising resting on five horizontal I-beams was undertaken, and the Finite Element Analysis (FEA) testing results from the initial design revealed that the I-beams could not withstand the weight of the tank and would lead to structural deformation. Further testing of the new tank with two internal baffles and three external frames revealed that deformation was still a key issue. Final testing on the tank with six internal baffles and eight internal supports revealed that when the tank was tested at 55 degrees Celsius with a 90% liquid fill, a slight deformation of 12.58 mm to the top of the tank was observed. This demonstrated an approximately 50% reduction in stresses. Further Finite Element Analysis (FEA) revealed the new tank resulted in:
A reduction in structural steel equating to 9.5 metric tonnes.
A reduction in stresses within the frame to provide a frame that falls within the materials stress parameters and is capable of being stacked three high with fully loaded tanks.
Reductions in overall tank deformation from 54 mm to 9 mm.

Testing of the AD tank: Following the development of the tank and support frames, testing was conducted with regard to gas agitation within the tank. The results of gas agitation tests on the 2000 L tank revealed that this technique was ineffective in keeping solids in suspension, and subsequently resulting in solids settling and blocking injection points.

Additional tests (i.e. using a pump to physically suck the liquid out of the bottom of the test tank and inject at a higher point) proved to be successful in separating the solids, however, an occasional blockage was still observed. Further iterations of tests confirmed that when the centrifuge pump was used to suck the liquid from the top (instead of from the bottom) and inject it at the bottom, the issue of solid blocking the inlet to the pump could be overcome.

Development of the anaerobic digester tank and frame: It was concluded that the final structure of the AD tank and structural frames achieved the hypothesised outcomes, e.g. minimal deformation, and significant reduction in stresses when filled with 90% liquid with a maximum weight of 350,000 kg. Further developments and testing will be conducted on-site, and any observations and learnings from this will contribute to the further development of the AD tank and frames.

Testing of the AD tank: It was concluded that by utilising the centrifuge pump to suck the liquid from the top of the tank whilst injecting from the bottom of the tank, the microorganisms within the injected liquid were preserved whilst maintaining the solids in suspension. This was achieved by gas agitation techniques using centrifuge pumps with specific injection directions (through the bottom). This will allow the microorganisms within the liquid to survive whilst ensuring solid suspension to avoid blockages to the pump inlets.

Finally, it could not be known if the agitation technique could maintain solids suspension whilst preserving the microorganisms within the liquid.

### 1. Design and Experimental Development of Anaerobic Digestion Processes

Through extensive research, UAG (i.e., the present inventor) observed that there were many methane digesters and power generation processes available in isolation in varying sizes. Similarly, there were many vermiculture systems, predominately domestic or small-scale operations, all of which are labour intensive. Additionally, there were many different types of grow-out systems available, including hydroponics, aeroponics and conventional growing systems in a glasshouse or open field. All these systems require the input of good quality fertilisers. However, to the knowledge of UAG, there are no competitors that have been able to:
emulate the natural process with automation;
remove the emissions from traditional waste treatment processes;
reduce labour with a similar quality output;
scale the process to accommodate small towns to large cities;
produce a tailored organic fertiliser suited to specific plants or crops;
use the tailored fertilisers to produce high valued niche crops; and
remove carbon from the waste environment and recycle it into energy and food.

UAG believes that the present inventor has developed an effective multi-stage anaerobic digestion process driven by natural bacteria to be the world first of its kind and would theoretically prevent acidification events and substantially enhance biogas quality and quantity. The traditional anaerobic processes are toxic to vermiculture. The concept then evolved to address the automated production of fresh salads, herbs and vegetables—‘designer fertiliser’, in the form of a new multi-stage process.

Thus, UAG hypothesised that a ‘screening to end-product methodology’ with the following stages:
removal of ammonia;
conversion of ammonium to nitrate;
removal of sulphide;
characterisation of bacteria strains;
pre-treatment processes; and
optimisation of CH₄ yield and stabilisation of the digestate.
   will be able to develop a colony in the digestion to remove toxicity and enhance certain features naturally, as well as significantly reduce the retention time of waste as anaerobic digestion feedstock, mitigate acidification processes, increase biogas yield and reduce the toxicity of its digestate on vermiculture.

### Experiment

Experiments were carried out with respect to the development of the anaerobic digestion (AD) and gas production processes based on a ‘screening to end-product methodology’. Specifically, the ‘screening to end-product methodology’ process consisted of the following steps:
Screening—Various different organic streams of material and their combinations are to be tested on both mesophilic and thermophilic processes. Various streams of materials including food waste, green waste and biomass and sewage waste are classified and prepared for assessment.
Evaluation in a laboratory environment—observations and evaluations will be made with regards to the AD process on different testing parameters using 15 litre AD devices for the various feed materials and the effects of these parameters on the AD performance. Toxicity on the worms will also be determined prior to entering vermiculture.
Confirmation—once the testing parameters from the laboratory environment are evaluated, further testing will take place using a larger volume of feed materials (i.e. 1000 litre (L)) and post-treatment and toxicity examination will be made on those materials before entering vermiculture.
Further application of a continuous Plug Flow AD process at a larger volume of materials (>1.7 cubic metre square (m3)) are then conducted.

To test the hypothesis on this AD optimisation process, UAG developed and tested the following procedures:

Removal of ammonia: a procedure that could successfully remove ammonia/ammonium from liquids and digestate using fulvic acid.

Conversion of ammonium to nitrate: a procedure that would allow the ammonium oxidising bacteria and nitrifier to be cultured and subsequently converted into nitrate.

Removal of toxic sulphide: a procedure that could successfully remove toxic sulphide from digestate using acidification and air-stripping methodologies, which was never applied in digestate before.

Bacteria strain characterisation: procedures and technologies are developed to allow the culture media to grow specific bacteria strains. Characteristics of these strains will also be analysed before treatment processes.

Pre-treatment processes: pre-treatment processes were developed to reduce the retention time of food waste as AD feedstock, mitigate acidification processes, increase biogas yield and reduce the toxicity of its digestate on vermiculture. For example, to prepare for the feed materials for the AD process from the waste, the waste will undergo a physical separation to remove non-organic contaminants, as well as to reduce the particle size of the feed materials. Additionally, treatments were undertaken to enhance the quality of digestate as a substrate for vermiculture. Additionally, microbial recalcitrant degradation was tested and evaluated using the “screening to end-product methodology”. Each of these techniques can enhance the overall performance of subsequent methane and fertilizer production.

### Evaluate Results

Each stage of the ‘screening to end-product methodology’ within the AD process will be assessed to determine the techniques that will be effective in producing biogas to enable microbial and bacterial decomposition of feed materials within liquids. Each of the procedures will be assessed, for example, whether the natural bacterial-driven AD process will effectively prevent acidification events and enhance substantially the quality and quantity of biogas. Furthermore, during these experiments, the impact of heat transfer, mechanical stress (pumps), chemical additions and other external stress factors on microbial digester cultures, biodigester performance and vermiculture will be assessed. Methodologies in mitigating these impacts will also be determined and assessed.

Preliminary results were obtained:
The quality of fulvic acid that was used in capturing all the ammonia released from the feed materials was found to be enhanced. This was due to the capture of ammonia, which acted as a nutrient in the soil. However, these results were obtained only in a laboratory environment setting, further testing using a larger volume of feed material (e.g. 1000 litre) will need to be carried out.
The successful conversion of ammonium bacteria of the digestate to nitrate suggested that this will enable the digestate as a food source for the vermiculture without any nitrogen related toxicity on the worms.
Characterisation of the bacterial strains revealed that the quality of the fertilisers was enhanced, and it was found to have characteristics including nitrogen-fixing, phosphorus solubilising, recalcitrant degrading, plant/root growth stimulating (hormones), nutrient/water uptake enhancing, nutrient/water storing and soil pH buffering abilities.

The biggest problems included the variations in moisture content of feed materials, the viscosity (water balance in the AD). To maximise the commercial viability, reducing the capital cost of construction, viscosity needs to be high.

The preparation of different types of waste for the AD process (e.g. separation and particle size reduction, pre-treatment) may vary due to the different organic and non-organic components within those waste.

World-first of its kind, of multi-stage AD process injunction with pre-treatment methodologies. It is intended that this process will:
enhance biogas yield (CH4/CO2 ratio and volume of the biogas) by cultivating efficient working microbial communities and bacterial strains;
reduce the retention time of the medium from feedstock to digest in the AD;
prevent acidification events in the AD;
prevent ammonia toxicity of digestate;

prevent inhibitory AD by-products (H2, S2-, NH3/NH4+, C/N ratio) on bacteria involved in the bio digestion process;
reduce the recalcitrant concentration to improve biogas production;
support a reliable running bio digestion;
enhance bio digestion performance;
eliminate the toxicity of digestate and enhance the quality of fertiliser by establishing co-digestion processes (e.g., biochar addition); and
produce digestate which is nourishing worms without any toxicity.

Research was undertaken to determine the production of biogas from various inputs of organic materials. Product preparation and the influence on production is important, for example, technical uncertainty involves the use of operating temperature at mesophilic or thermophilic temperatures during the process.

Additionally, there lacks an advanced understanding of the effect of feed materials' viscosity on the AD process. Therefore, it cannot be known whether the parameters, such as operating temperature and water content, will be effective at digesting a variety of feed materials with zero waste and zero-emission.

Additionally, it cannot be determined which type, and volume, of gases would result from the AD process without undergoing a systematic progression of work.

### Step 5—Vermiculture

Vermiculture treatment of the AR digestate using stacked, vermiculture modules.

### Vermiculture Processes

To achieve full scale colonisation of the vermiculture facility at the commencement of operations and then later during continuous production operation treating AR digestate, care must be taken in the processes of breeding of worms, delivering worms to a vermiculture cell, and the delivery of worms from cell to cell to propagate the entire plant. This requires specific equipment, workflow methods and worm husbandry expertise.

### Breeding of Worms for Start-Up of Vermiculture Processes

A typical full-scale waste treatment facility using AD in combination with vermiculture can require a 5-tonne quantity of worms to populate it to be able to properly treat the volume of waste feed material. The breeding program can take around 200 days to reach this weight of worms.

Breeding may involve either live worms or worm cocoons. In each case the worm delivery to site will require knowledge of specific operational parameters such as:
worm weight per unit volume to populate the cells;
worm breeding time; and
whether to utilise offsite or onsite breeding.

Worm breeding begins offsite before the main construction effort begins, at around 150 days prior to the completion of the vermiculture housing of the facility. Typically, shipping containers are used to house a cluster of vermiculture modules which are transported to site to enable the population to be expanded. The transportable containerised modules may be operated offsite, prior to the commissioning of the plant.

Breeding occurs within vermiculture modules, which are described elsewhere in this specification. These modules receive organic waste feedstock as a slurry, drain it and then push worms, along with their substrate, onto further processes.

These processing modules must be operational at the start of any worm breeding stages onsite. The worm feed rate for worm breeding purposes is up to 3 tonnes per day. The vermiculture modules within the facility to be operational for receival of slurry, including slurry transfer controls, pumps and slurry distribution infrastructure.

### Splitting the Worm Population for Propagation

Various broad scenarios for breeding worms can include using combinations of live worms, juvenile worms and seeding some modules with worm cocoons complete in their substrate. However this is achieved, the vermiculture system will have every one of the modules populated with worms during full operation. Accounting for some loss of worms is also needed, due to expected losses when the content of the worm beds are subject to various separation techniques.

The technique of using worm cocoons to seed modules is of importance, as it allows a population explosion to be released when a vermiculture plant is ready to commence operation. Cocoons are readily stored over the long term, and are easily transported and easily seeded into new feedstock.

The aim of the breeding program is to grow a worm population during the time that it takes to build and to commission the waste treatment plant. At the end of commissioning the worm population weight shall be capable of eating the nominal rate of feedstock supplied to them by at the normal rate of operation.

Two methods of breeding scenarios possible are:
Splitting the complete mix—propagating new feed with a complete mix of substrate, adult and juvenile worms along with substrate; and/or
Cocoon breeding—using a stock of worms for breeding cocoons, seeding new vermiculture modules with cocoons only.

While all methods of breeding worms hinge upon the production of cocoons, the latter method provides them in large quantities. The initial breeding stock may be of any size, used to produce any number of cocoons over a required time, upon demand. Cocoons may be bred well in advance of their application. The cocoons take 24 days to hatch from when they are laid. Cocoon storage will be required, but the cocoons may be compacted and stored using standard refrigerator equipment. Transport of cocoons is also easily managed, with care only to keep them dry (therefore preserved and dormant).

Cocoon breeding is used to breed and store any size stock of cocoons ready for a bulk delivery. Worms are kept in a steady state population, and cocoons routinely harvested from the moving module belt, separated and placed in a holding bin. The cocoons are returned to the feedstock. The worms are separated using 6 mm trommel, and then the worm cocoons are separated using 3 mm trommel. The cocoons may be stored for future use or as a product for sale.
2 of 40 ft 12 modules each, own intake, output, controls;
feed for the worms is milled and sterilised (free of insects at all stages of lifecycle); and
live worms are delivered by pump in a slurry; worm cocoons are delivered with a dry humus material.

Either method of worm population is used to cause an exponential growth of the worm population prior to beginning the intake of feed organic waste stock for routine operation. A typical timeline requires 130-150 days to seed all modules with worms in a full-scale plant, and about 200 days to reach full population and full feed rate to the modules.

The process flow is outlined in the following summary points:
Portable Module;
Conveyor;
Holding mixing tank/bin; and
Conveying Pump & hose for mixing and distributing slurry to vermiculture.

### Vermiculture Initiation and Worm Propagation

### Materials Receiving

Prior to receiving any AR digestate, a typical initial feedstock mixture to a vermicomposting system may be a combination of manure, food waste, and green waste. The feedstock is received by truck, and after weighing is unloaded and its composition characterised (normally by an initial estimate of its properties).

### Materials Milling and Sterilisation

The feed is then milled, mixed with different feedstocks, and then sterilised by pasteurisation for hygiene purposes (so that insects, larvae and eggs are made unviable). The feed is then held in compost humus (moist) in a tank until a batch volume is accumulated, whereupon it is then transferred to vermiculture modules in a water slurry mix. A portable delivery module may be used for this purpose. The excess liquid drains from the vermiculture modules and is transferred back to the water treatment part of the plant. At future times, the worms are then transported/distributed between modules by use of a slurry pump to cause splitting of the population for seeding any newly operable vermicomposting modules.

### Portable Module

Initial breeding can occur in portable vermiculture modules, which are mounted in portable shipping containers. These containers can be moved to site prior to the required time for populating the larger number of vermiculture modules housed in the new facility.

Whether mounted in a shipping container, or located within a building structure on site, all vermicomposting modules are housed in air conditioned and insect proof conditions.

### Conveyance and Storage

Bulk materials handling of product (worms and substrate) exiting from the portable vermicomposting modules is conducted by using a conveyor belt, and into a mixing tank.

As they grow, the worms are temporarily held in a buffer tank, with due care to the time limitation of thick beds (as worm will die). Water is added last minute, and worms (with their substrate) are gently mixed with water into slurry.

The worms are pumped in a slurry, which is distributed to each of the modules. The worms can be flushed and recovered from the system using fresh water. During use, liquids are drained from the modules and sent to the waste treatment plant.

The breeding program continues with escalating feeding rates of organic material supplied to all modules as the worm population escalates.

The experience for the worms, (the process flow from a worm eye view) is, that they are continuously fed organic waste and breed. Occasionally they will fall off the moving module belt conveyer as it moves along.

The humus made during the worm breeding exercise is different to that humic material which is made from the worms fed with AD product. Until the transition to AD production, the humus will have a different specification to be noted for the product. Any delay to the commissioning will require the continued feeding and breeding of worms. The additional time may be used to produce additional worm population to propagate which may be useful in condensing the time from seeding to steady state worm mass.

After the initial start-up, the feed to the modules transition from sterilised manure-based feedstock, to using the digestate feed supplied from the Anaerobic Digestion process part of the facility. Commissioning of the following items of plant is required to enable timely feeding of the worms with the AD digestate: slurry tanks and transfer equipment, supporting control systems, and gas processing. For many facilities, a transition to feeding the vermiculture process with AD digestate is made anywhere from 150-200 days from commencement.

### Portable Worm Propagation Units (Shipping Containers)

A transportable breeding facility is used as it enables the breeding to begin offsite, before the main facility is commissioned and before ground is broken on the site. It allows propagation of the plant with copious quantities of worms when the plant is ready. Propagation of 4800 kg of worms is a time-consuming process that may occur parallel to other activities compressing the time to operation.

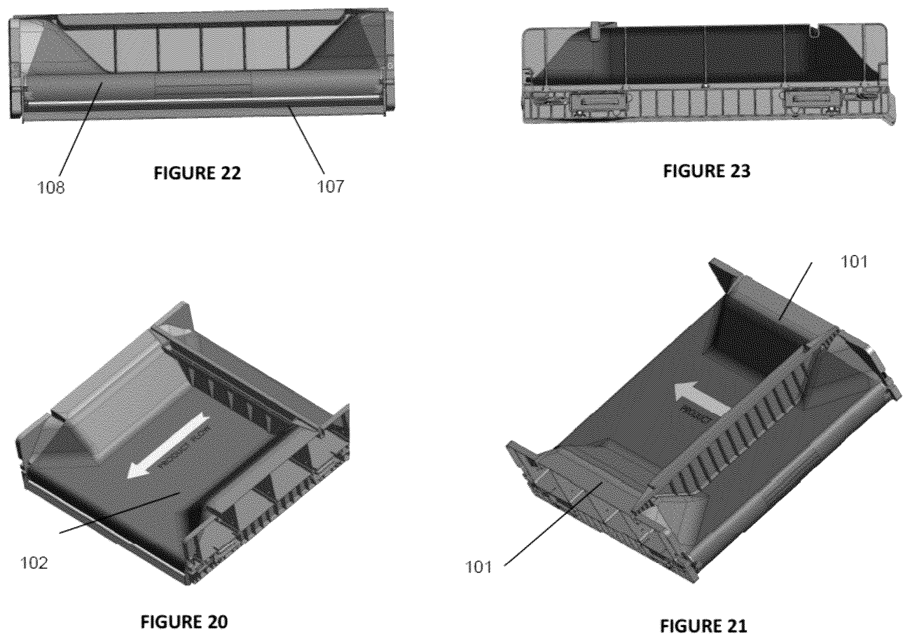

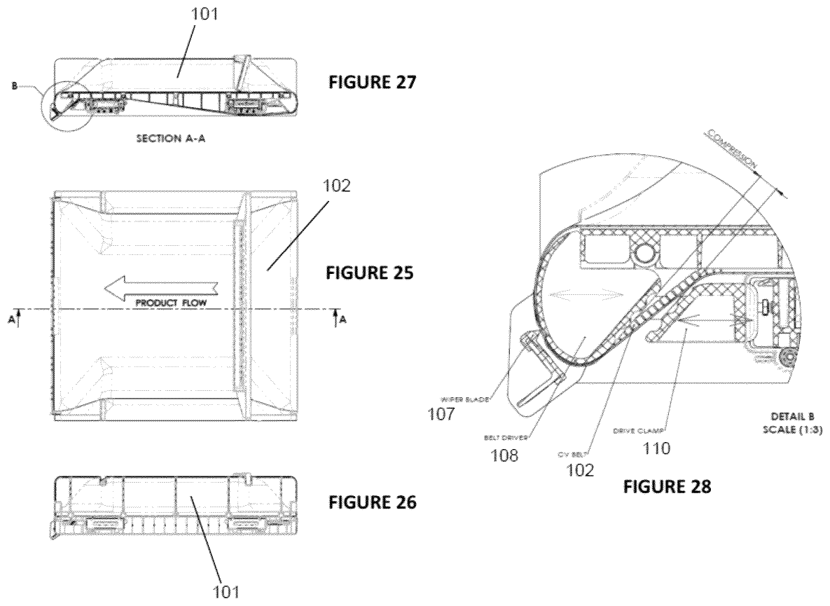

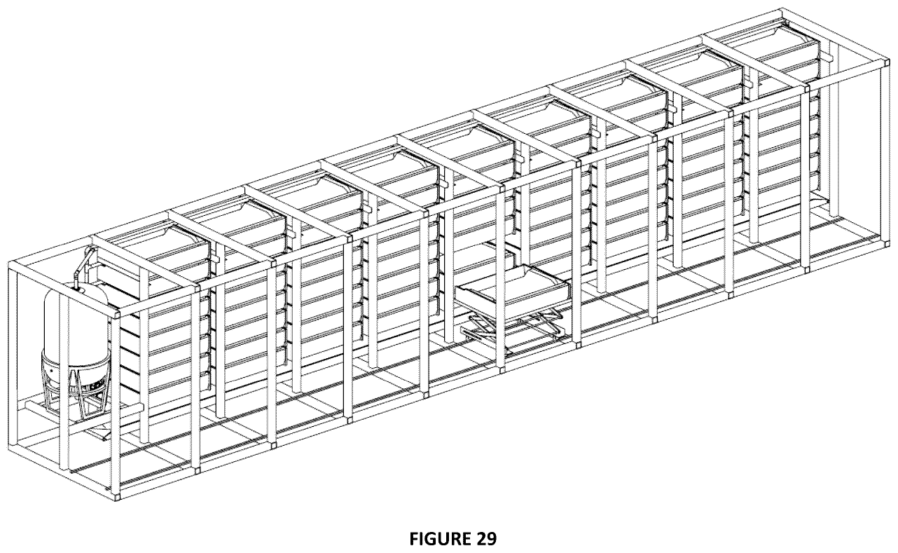

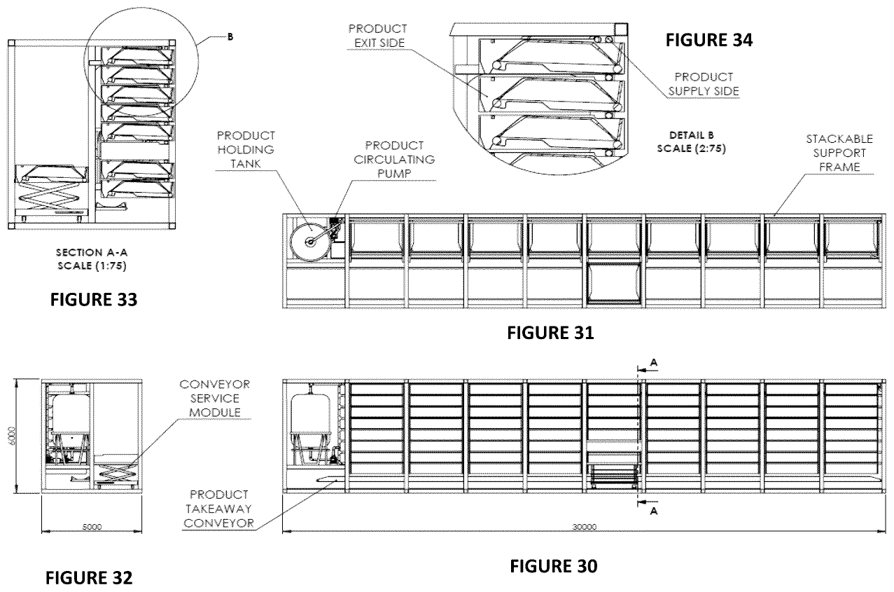

As depicted in FIGS. 20 to 28, the Applicant's BioN Modules are designed for the purpose, with notable functions such as receival of food in slurry form, drainage of liquids and automated discharge of mature humus material. For this reason, the Portable Worm Propagation Units, depicted in FIGS. 29 through 34, form a housing to the BioN Modules to propagate the worms within.

The Portable Worm Propagation Units must be able to be transported between sites, by truck, maintaining livestock health in transit. An APU is utilised for maintenance of air conditioning during transit. The BioN Modules are housed within 2 insulated 40 ft shipping containers.

The Portable breeding facility depicted in FIGS. 29-34 includes a feedstock preparation unit, comprising a 20 ft container with milling, mixing, sterilisation, slurry making, slurry transfer pump to modules and washdown facilities. This unit is deployable, to allow feeding to occur at the main facility before commissioning of many of the supporting infrastructure.

### Development of a Non-Motorised Conveyor Module

The inventor sought to develop a non-motorised conveyor 102, that does not require the use of an electric motor or rollers, that is capable of controlling and monitoring the operation of the module with feedback to a central control system.

The developed non-motorised conveyor module can fully contain liquid and humus using angled sides and a profile. Specifically, if the conveyor (CV) belt 102 from the module is stable in both vertical and horizontal directions, and can be gripped mechanically with sufficient compression to allow for a loaded belt to be pushed or dragged over a static surface without causing damage to the belt 102.

The module is:
lightweight and be able to transfer materials of up to 700 kilograms (kg);
able to index short distances of approximately 5 to 50 millilitres when requested;
generates no heat;
generates no vibration; and
capable of being extracted from a module mounting rack as shown in FIGS. 29-34 with minimal human intervention.

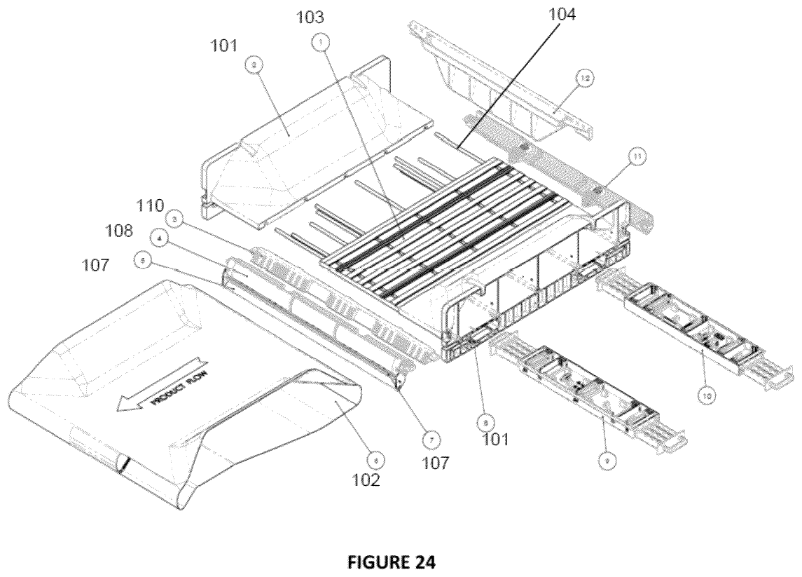

Referring to FIG. 24, the drawing shows a conveyer (CV) belt 102, supported by a conveyer bed 103, which is itself supported by 11 reinforcing tubes 104. Each side of the conveyer belt 102 is supported by a conveyer side 101. Development of this device with a lightweight base structure 103, 104 in conjunction with conventional rollers at both ends of the module enabled the belt drive mechanism 108 to be operated pneumatically.

The forward motion of the belt is driven by the difference of friction between the loaded side of a belt 102 and the detention side 110 of the belt drive mechanism 108. The conveyor module is angled to allow for liquid to flow and to pool toward the rear of the upper deck of the module when materials entered the conveyor, which removes the ingress of liquids to the belt drive mechanism 108 and avoids contamination.

The conveyor mechanism allows the angled belts to convey over distance with minimal vibration, and liquid contamination to the belt drive mechanism 108 is avoided.
Construction materials to be plastics, using recycled plastics where possible;
Belt profile to manage the 700 kg load;
Structural integrity under a rack mounting;

To enable the materials (a moist humus material containing a colony of live worms) to be transferred whilst generating an environment that would allow the worms to live and thrive, the inventors developed a fully contained, non-motorised conveyor module that will be able to transfer a slurry of up to 700 kg and will generate zero heat, zero vibration with no human intervention, generating a condition to allow the worms to consume the humus during the transfer of the materials, as the conveyor bed 103 slowly moves toward the discharge wiper blade 107.

Use of the module with angled sides 101 and base provides support of the conveyor belt 102 in both vertical and horizontal planes.

The angled and non-motorised design will result in a friction-drive mechanism and enable the slurry materials (a colony for live worms) to be transferred over distances without causing the materials to be stuck onto the belts and causing a harmful environment for the worms to live.

The humus slurry is viscous, but with the addition of water into the material, making a slurry of 70-80%, it was observed that the slurry was able to be evenly flown into the module, but that a flatbed was not suitable and a conveyor with upturned edges to contain all liquid and humus would be required to overcome this issue.

### Step 6—Fertiliser Production

Fertilisers and compound solutions as final products of the process are the result.

Third party tests on fertiliser outputs have shown that the fertiliser output is superior to composts and organic fertilisers.

The production equipment used comprises off-the-shelf technologies in preparation and packaging.

1. A method for treating organic waste feed material to decompose it, the method comprising the steps of:
treating a quantity of said organic waste using a two-stage anerobic digestion process comprising:
a primary treatment stage with process parameters arranged to optimise hydrolysis and acidogenesis of the organic waste; which is separate to
a secondary treatment stage with its process parameters arranged to optimise anerobic digestion of an output product of said primary treatment stage;
and then
treating at least some product digestate output from the two-stage anaerobic digestion process by using a vermiculture process, resulting in the output of solid and liquid fertilizer products.

2. (canceled)

3. The method as claimed in claim 1, wherein the primary treatment stage is operated in a batch-like manner.

4. The method as claimed in claim 1, further comprising the step of classifying the organic waste feed material by particle size, prior to the primary treatment stage.

5. The method as claimed in claim 3, wherein said step of size classification comprises the use of a particle size classification apparatus, being one or more of the group consisting of: a screen; a specific gravity separator which uses air, such as an air separator; a specific gravity separator which uses water, such as a centrifuge, or a wet separation table.

6. The method as claimed in claim 3, further comprising the step of causing a reduction in size of oversize particles of organic waste feed material which are present, prior to the primary treatment stage.

7. The method as claimed in claim 6, wherein said step of causing a reduction in size of oversize particles of organic waste feed material comprises the use of a particle size reduction apparatus, being one or more of the group consisting of: a mill; a mascerator; a shredder.

8. The method as claimed in claim 1, further comprising the step of classifying the type and source of organic waste feed material from its initial composition, prior to the primary treatment stage.

9. The method as claimed in claim 4, wherein at the commencement of the primary treatment stage, a quantity of water and a quantity of organic waste feed material which has been classified, are added together in a vessel and agitated, to create a uniformly-mixed slurry.

10. The method as claimed in claim 9, in which optimisation of the hydrolysis and acidogenesis steps of anaerobic digestion of the slurry in the primary treatment stage includes steps for selecting, monitoring and controlling at least one of the following parameters: temperature; pH; addition of microorganism inoculant(s); addition of decontaminant; solid to liquid ratio insofar as it affects the viscosity of the mixed slurry; particle size of the organic waste solids; C:N ratio in the organic waste solids.

11. The method as claimed in claim 10, wherein the step of monitoring and controlling slurry temperature in the primary treatment stage is by use of a thermocouple located in contact with the slurry in the vessel, wherein the thermocouple is in communication with a controller for a pump which is arranged in use to either control a flow of the slurry, or a flow of fluid in a heat exchanger, in respective relation to one another.

12. The method as claimed in claim 10, wherein the step of monitoring and controlling slurry pH in the primary treatment stage is by use of a pH detection probe located in contact with the slurry in the vessel, wherein the pH detection probe is in communication with a device which is arranged in use for controlled metering of acid or base solution into the slurry.

13. The method as claimed in claim 10, wherein in use the vessel can be sealed to prevent entry of oxygen, and purged of any oxygen present inside, by the step of introducing an inert gas thereinto, prior to commencement of the primary treatment stage.

14. The method as claimed in claim 10, wherein during the operation of the primary treatment stage, the vessel, which comprises an elongate tank which is arranged for entry of the slurry via an uppermost region at one end of the tank, and exit of the slurry from a lowermost region at the opposing end of the tank, is arranged to be filled with the slurry to between 80-90% of its volumetric capacity volume.

15. The method as claimed in claim 10, wherein during the operation of the primary treatment stage, the slurry in the vessel becomes agitated by causing supernatant slurry to move out of an uppermost region of the interior of the vessel, via an external pipe, which is arranged externally of the vessel and which is in fluid communication with the interior of the vessel at both the uppermost region and the lowermost region thereof, and to re-enter the vessel at said lowermost region, thereby creating agitation of the same slurry into itself.

16. The method as claimed in claim 15, wherein the external pipe outside of the vessel is in fluid communication with a slurry pump, the slurry pump being capable of drawing a slurry flow through the external pipe, when in use.

17. The method as claimed in claim 16, wherein at least some of the length of the external pipe which is outside of the vessel is at least partially surrounded with a heat exchanger in the form of a hollow sleeve, the interior of which is in fluid communication with a source of heated fluid, and operable so that if the heated fluid is recirculating through the heat exchanger hollow sleeve, then as slurry is caused to flow through the external pipe it also becomes heated in use.

18. The method as claimed in claim 1, wherein operation of the secondary treatment stage commences when a quantity of water and the output product of the primary treatment stage is passed into a further anaerobic digestion vessel in which the organic waste is agitated and heated in the absence of oxygen.

19. The method as claimed in claim 18, wherein the secondary treatment stage is operated in a batch-like manner.

20. The method as claimed in claim 18, in which the anaerobic digestion of the partially treated organic slurry output of the primary treatment stage includes further steps for selecting, monitoring and controlling at least one of the following parameters: temperature; pH; addition of microorganism inoculant(s); addition of decontaminant; solid to liquid ratio insofar as it affects the viscosity of the mixed slurry.

21. The method as claimed in claim 18, further comprising the steps of production and recovery of product gases collected during the anaerobic digestion of the organic matter, including the further steps for at least one of the following: desulphurisation of the product gases; removal and collection of carbon dioxide; removal of ammonia and methane impurities from the carbon dioxide; compression of carbon dioxide into a liquid form; re-use of methane and ammonia as a combustion fuel.

22. The method as claimed in claim 1, wherein following the treatment of the organic waste feed material using said two-stage anaerobic digestion, the product digestate output is treated by said vermiculture process, the use of which results in the production of carbon-rich humus fertiliser.

23. A method for treating an organic waste material to decompose it, the method comprising the steps of:
treating a quantity of organic waste using a multi-stage, anerobic digestion process which is arranged to reduce the waste retention time of the process, and to mitigate against the possibility of an acidification event that results in a digestate being formed containing ammonia, hydrocarbon and sulfide inhibitors for bacteria, the process having:
a primary treatment stage arranged to operate under thermophilic processing conditions to enhance hydrolysis and acidogenesis of the organic waste; followed by
a secondary treatment stage arranged to operate under mesophilic processing conditions to enhance anerobic digestion of an output of the primary treatment stage;
and then
treating at least some of the product digestate output from the multi-stage anaerobic digestion process using a vermiculture process, resulting in the output of solid and liquid fertilizer products.

24. The method as claimed in claim 23, wherein the primary treatment stage is operated in a batch-like manner.

25. The method as claimed in claim 23, further comprising the step of classifying the organic waste feed material by particle size, prior to the primary treatment stage.

26. The method as claimed in claim 23, further comprising the step of causing a reduction in size of oversize particles of organic waste feed material which are present, prior to the primary treatment stage.

27. The method as claimed in claim 23, further comprising the step of classifying the type and source of organic waste feed material from its initial composition, prior to the primary treatment stage.

28. The method as claimed in claim 23, in which optimisation of the hydrolysis and acidogenesis steps of anaerobic digestion of the slurry in the primary treatment stage includes steps for selecting, monitoring and controlling at least one of the following parameters: temperature; pH; addition of microorganism inoculant(s); addition of decontaminant; solid to liquid ratio insofar as it affects the viscosity of the mixed slurry; particle size of the organic waste solids; C:N ratio in the organic waste solids.

29. The method as claimed in claim 23, wherein operation of the secondary treatment stage commences when a quantity of water and the output product of the primary treatment stage is passed into a further anaerobic digestion vessel in which the organic waste is agitated and heated in the absence of oxygen.

30. The method as claimed in claim 23, wherein the secondary treatment stage is operated in a batch-like manner.
